(19) United States
(12) Patent Application Publication
(10) Pub. No.: US 2025/0315761 A1
(43) Pub. Date: Oct. 9, 2025

(54) WORK SUPPORT METHOD AND SYSTEM

(71) Applicant: SAMSUNG SDS CO., LTD., Seoul (KR)

(72) Inventor: Su Young KIM, Seoul (KR)

(73) Assignee: SAMSUNG SDS CO., LTD., Seoul (KR)

(21) Appl. No.: 19/076,640

(22) Filed: Mar. 11, 2025

(30) Foreign Application Priority Data
Apr. 4, 2024 (KR) 10-2024-0046123
May 23, 2024 (KR) 10-2024-0066956

(51) Int. Cl. G06Q 10/0633

(52) U.S. Cl. CPC G06Q 10/0633

(57) ABSTRACT

There is provided a work support method performed by a computing system. The work support method may comprise acquiring a plurality of pieces of summary information for a specific project using a plurality of data stored in a storage, the plurality of pieces of summary information being associated with different categories, generating a plurality of pieces of card-type information associated with different categories, using the plurality of pieces of summary information and generating status information for the specific project including at least one of the plurality of pieces of card-type information.

### CROSS-REFERENCE TO RELATED APPLICATIONS

This application claims priority from Korean Patent Application No. 10-2024-0046123 filed on Apr. 4, 2024 and Korean Patent Application No. 10-2024-0066956 filed on May 23, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a work support method, and more specifically, to a work support method and system that generate status information regarding a project and automatically respond to inquiries based on the status information.

### 2. Description of the Related Art

Users perform separate confirmation tasks, such as accessing an internal system or checking memos, to grasp the status of their own or others' work. However, these confirmation tasks may require a significant amount of time.

Accordingly, technologies have been developed to assist users in understanding specific work tasks via chatbots. However, answering specific inquiries using chatbots requires pre-generating numerous responses corresponding to a vast number of questions. As a result, a considerable amount of time and labor must be invested in advance to provide chatbot services. Furthermore, if work-related content changes, a plurality of responses must also be updated to reflect the changes.

As a result, there is a growing demand for technology that allows users to conveniently grasp work status and can efficiently provide work-related chatbot services.

### SUMMARY

An objective of the present disclosure is to provide a work support method and system that present category-based card-type information, enabling a user to easily understand work status.

Another objective of the present disclosure is to provide a work support method and system that generate an accurate response to an inquiry and transmit the generated response to a user terminal.

Yet another objective of the present disclosure is to provide a method and system for improving the performance of an artificial intelligence (AI) model by fine-tuning the AI model based on a user's reactions to responses.

The objectives of the present disclosure are not limited to those mentioned above, and other objectives not explicitly stated will be clearly understood by those skilled in the art based on the following description.

According to an aspect of the present disclosure, there is provided a work support method performed by a computing system, the work support method may comprise acquiring a plurality of pieces of summary information for a specific project using a plurality of data stored in a storage, the plurality of pieces of summary information being associated with different categories, generating a plurality of pieces of card-type information associated with different categories, using the plurality of pieces of summary information and generating status information for the specific project including at least one of the plurality of pieces of card-type information.

In some embodiments, the plurality of pieces of summary information may include first summary information associated with a first category and second summary information associated with a second category, the first category may be associated with a plurality of data generated through a first application, and the second category may be associated with a plurality of data generated through a second application.

In some embodiments, the acquiring the plurality of pieces of summary information for the specific project may comprise inputting text requesting information related to the specific project into a first artificial intelligence (AI) model and acquiring the plurality of pieces of summary information through the first AI model.

In some embodiments, the generating the plurality of pieces of card-type information may comprise inputting the plurality of pieces of summary information into a second AI model, and acquiring the plurality of pieces of card-type information through the second AI model, and the second AI model may be configured to output the plurality of pieces of card-type information based on the plurality of pieces of summary information.

In some embodiments, the second AI model may be configured to calculate confidence scores for the plurality of pieces of summary information, select at least one of the plurality of pieces of summary information based on the calculated confidence scores, and output the plurality of pieces of card-type information using the selected at least one piece of summary information.

In some embodiments, the second AI model may be further configured to calculate the confidence scores for the plurality of pieces of summary information based on a frequency of overlapping keywords or words included in each of the plurality of pieces of card-type information.

In some embodiments, the work support method may further comprise after the generating the status information, receiving an inquiry related to the specific project from a user terminal, generating a response to the inquiry based on the plurality of pieces of card-type information included in the status information and transmitting the generated response to the user terminal.

In some embodiments, the generating the response to the inquiry may comprise inputting text instructing a first AI model to generate a response to the inquiry by referring to the plurality of pieces of card-type information included in the status information into the first AI model and acquiring the response from the first AI model.

In some embodiments, the first AI model may be configured to generate the response to the inquiry by referring to the plurality of pieces of card-type information in descending order of confidence scores.

In some embodiments, the generating the response to the inquiry may comprise receiving user input selecting at least one piece of card-type information for generating a response from among the plurality of pieces of card-type information included in the status information and generating the response based on the at least one piece of card-type information selected by a user.

In some embodiments, the work support method may further comprise after the generating the status information, receiving a request for information regarding the specific project from a user terminal and transmitting the status information to the user terminal, wherein a portion of first card-type information included in the status information is displayed in a first output area of the user terminal, and a portion of second card-type information included in the status information is displayed in a second output area of the user terminal.

In some embodiments, the work support method may further comprise after the generating the status information, receiving a request for information regarding the specific project from a user terminal, extracting periodic status information for the specific project and transmitting the periodic status information to the user terminal.

In some embodiments, the work support method may further comprise after the generating the status information, receiving a response history request from a user terminal, extracting inquiries and responses to the inquiries and transmitting the extracted inquiries and responses to the user terminal.

In some embodiments, the work support method may further comprise receiving positive or negative feedback on the responses from the user terminal and generating training data including the positive or negative feedback, the inquiries, and the responses, wherein the training data may be used to additionally train a first AI model.

In some embodiments, the work support method may further comprise after the generating the status information, determining whether a number of pieces of card-type information included in the status information is greater than or equal to a threshold, when the number of pieces of card-type information included in the status information is less than the threshold, searching for and finding data related to the specific project in at least one of an internal system and an external system, additionally generating card-type information based on the found data and including the additionally generated card-type information in the status information.

In some embodiments, the work support method may further comprise after the generating the status information, when a scheduled time for updating the status information arrives, additionally acquiring a plurality of pieces of summary information for the specific project based on the plurality of data stored in the storage and updating the status information for the specific project based on the additionally acquired summary information.

In some embodiments, when an inquiry regarding the specific project is received, it may be determined that the scheduled time for updating the status information has arrived.

In some embodiments, when additional data related to the specific project is detected as being stored in the storage with a size exceeding a threshold, it may be determined that the scheduled time for updating the status information has arrived.

According to an aspect of the present disclosure, there is provided a computing system. The computing system may comprise one or more processors and a memory storing a computer program executed by the one or more processors, wherein the computer program may include instructions for operations of acquiring a plurality of pieces of summary information for a specific project using a plurality of data stored in a storage, the plurality of pieces of summary information being associated with different categories, generating a plurality of pieces of card-type information associated with different categories using the plurality of pieces of summary information, and generating status information for the specific project including at least one of the plurality of pieces of card-type information.

According to an aspect of the present disclosure, there is provided a non-transitory computer-readable recording medium. The non-transitory computer-readable recording medium may comprise instructions, wherein when executed by a processor, the instructions enable the processor to perform operations of acquiring a plurality of pieces of summary information for a specific project using a plurality of data stored in a storage, the plurality of pieces of summary information being associated with different categories, generating a plurality of pieces of card-type information associated with different categories using the plurality of pieces of summary information and generating status information for the specific project including at least one of the plurality of pieces of card-type information.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram illustrating a work support system according to an embodiment of the present disclosure;

FIG. 2 is a diagram illustrating the generation of a plurality of pieces of card-type information using a first artificial intelligence (AI) model and a second AI model, according to an embodiment of the present disclosure;

FIG. 3 is a diagram illustrating an artificial neural network model according to an embodiment of the present disclosure;

FIG. 4 is a flowchart for explaining a method of generating status information regarding a project, according to an embodiment of the present disclosure;

FIG. 5 is a flowchart for explaining a method of generating additional card-type information and including the generated additional information in status information, according to an embodiment of the present disclosure;

FIG. 6 is a flowchart for explaining a method of providing status information regarding a project, according to an embodiment of the present disclosure;

FIG. 7 is a diagram illustrating a plurality of pieces of card-type information displayed within status information, according to an embodiment of the present disclosure;

FIG. 8 is a flowchart for explaining a method of automatically generating and transmitting a response, according to an embodiment of the present disclosure;

FIG. 9 is a flowchart for explaining a method of fine-tuning the first AI model through retraining based on user feedback on responses, according to an embodiment of the present disclosure;

FIG. 10 is a diagram illustrating a plurality of inquiries and responses transmitted to and displayed on a user terminal;

FIG. 11 is a flowchart for explaining a method of updating status information regarding a specific project, according to an embodiment of the present disclosure; and

FIG. 12 is a diagram illustrating the hardware configuration of a computing system, according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Before explaining embodiments of the present disclosure, the terms used herein will hereinafter be described.

In the embodiments of the present disclosure, a “category” may refer to data grouped based on common attributes. Here, the common attributes may relate to at least one of applications, databases, and uses. For example, a first category may refer to a plurality of data generated through a first application, and a second category may refer to a plurality of data generated through a second application. As another example, the first category may refer to a plurality of data stored in a first database, and the second category may refer to a plurality of data stored in a second database. As yet another example, the first category may refer to a plurality of data associated with a first use, and the second category may refer to a plurality of data associated with a second use.

In the embodiments of the present disclosure, “card-type information” may be understood as a plurality of data used to configure information displayed in a card format within a specific area of a screen. For example, card-type information may include one or more of a summary of a specific task, schedules, responsible personnel, images, or files, may be displayed within a specific area of a screen.

Embodiments of the present disclosure will hereinafter be described in detail with reference to the accompanying drawings.

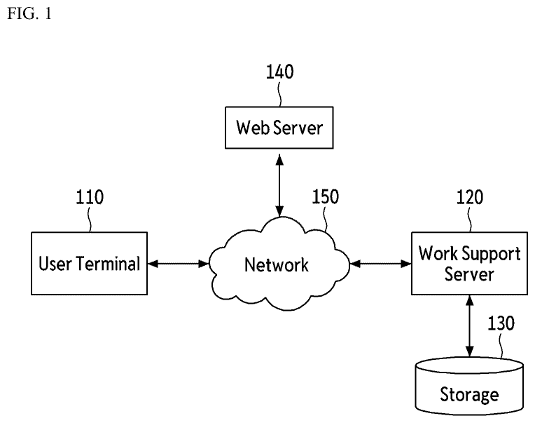

FIG. 1 is a diagram illustrating a work support system according to an embodiment of the present disclosure.

Referring to FIG. 1, the work support system according to an embodiment of the present disclosure may include a user terminal 110, a work support server 120, and a storage 130.

The user terminal 110, the work support server 120, and a web server 140 may communicate with each other through a communication network 150. Here, the communication network 150 may include both mobile and wired communication networks, which are well-known conventional technologies and thus will not be described in detail.

The user terminal 110 may access the work support server 120 to receive and output status information for one or more projects. For example, the user terminal 110 may request status information regarding Project A from the work support server 120 and receive and display the status information. In one embodiment, the user terminal 110 may display each of a plurality of pieces of card-type information included in the status information. In this case, the user terminal 110 may generate a number of output areas of a predetermined size corresponding to the number of pieces of card-type information and display part of a piece of card-type information within one output area. Card-type information may be displayed in a card format with enhanced readability. Only part of card-type information may be displayed within one output area, and when the output area is selected, the whole card-type information may be displayed via a popup window or full screen. Additionally, the user terminal 110 may send an inquiry regarding a specific task to the work support server 120 and receive a response from the work support server 120.

The web server 140, which is a server capable of providing a portal service, may provide a search service. For example, when a specific search term is received from the user terminal 110 or the work support server 120, the web server 140 may perform a search using the search term and send results of the search to the user terminal 110 or the work support server 120.

The storage 130 may be means for storing a large amount of data, including various project-related data. In one embodiment, the storage 130 may include category-specific databases. For example, the storage 130 may include a first database associated with a general messenger category, a second database associated with a meeting category, a third database associated with an email category, a fourth database associated with a team messenger category, a fifth database associated with a memo category, a sixth database associated with a network driver category, a seventh database associated with an internal portal service category, and an eighth database associated with an internal work system.

In some embodiments, the storage 130 may store subscriber information, such as user names and addresses. Additionally, the storage 130 may store training datasets for training first and second artificial intelligence (AI) models that will be described later.

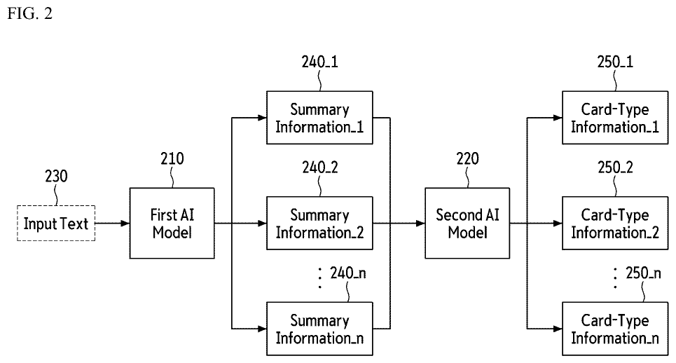

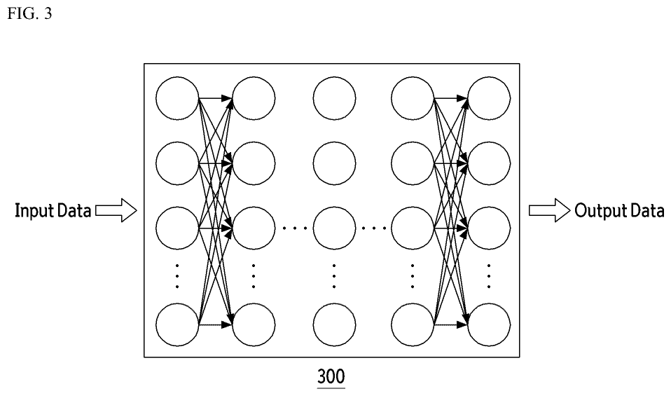

The work support server 120 may generate status information regarding a project to facilitate the understanding of work and transmit the generated status information to the user terminal 110. In one embodiment, when a request is received for information regarding a specific project from the user terminal 110, the work support server 120 may transmit status information for the specific project to the user terminal 110. In one embodiment, the work support server 120 may retrieve a plurality of pieces of summary information regarding the specific project based on a plurality of data stored in the storage 130 and generate a plurality of pieces of card-type information based on the retrieved summary information. According to another embodiment, the work support server 120 may input a text query requesting information regarding the specific project into the first AI model and retrieve the plurality of pieces of summary information based on the output from the first AI model. The work support server 120 may then input the retrieved summary information into the second AI model and generate the plurality of pieces of card-type information based on the output from the second AI model. The first and second AI models used will be described later in detail with reference to FIGS. 2 and 3.

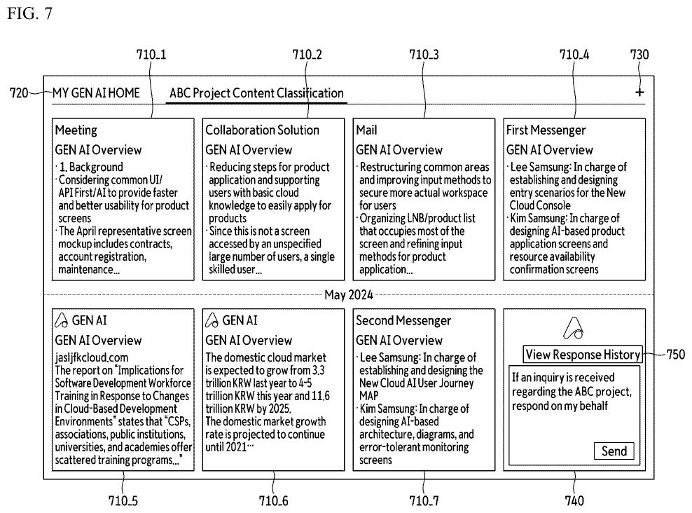

In one embodiment, the work support server 120 may generate status information regarding the specific project that includes one or more pieces of card-type information and transmit the generated status information to the user terminal 110. The status information may be displayed as a plurality of cards on the user terminal 110. The status information will be described later with reference to FIG. 7. When the status information is generated, a folder for storing files related to the status information may also be created, and the related files may be stored in the folder. In some embodiments, each piece of card-type information included in the status information may be saved as a separate file in the folder.

In one embodiment, the work support server 120 may receive an inquiry related to the specific project from the user terminal 110. In this case, the work support server 120 may automatically generate a response to the inquiry based on at least one piece of card-type information included in the status information for the specific project and transmit the generated response to the user terminal 110. In some embodiments, the work support server 120 may input text giving instructions to generate a response to the inquiry based on at least one piece of card-type information included in the status information for the specific project into the first AI model and retrieve the response from the first AI model.

The work support system according to an embodiment of the present disclosure has been described so far with reference to FIG. 1. According to the present embodiment, status information that enables a user to easily grasp the schedules, responsible personnel, and summaries of a project may be generated and provided to the user. Here, the user may be a participant in the project or a person interested in the project. Additionally, responses to inquiries related to the project may be automatically generated. Furthermore, by automatically generating responses based on the status information, the accuracy of the responses can be improved.

First and second AI models used in embodiments of the present disclosure will hereinafter be described with reference to FIGS. 2 and 3.

FIG. 2 is a diagram illustrating the generation of a plurality of pieces of card-type information 250_1, 250_2, . . . , 250_n using a first AI model 210 and a second AI model 220, according to an embodiment of the present disclosure. Referring to FIG. 2, the first and second AI models 210 and 220, which are pre-trained models, may include artificial neural networks.

Referring to FIG. 2, input text 230 may be input to the first AI model 210. Here, the input text 230 may be expressed in natural language, written by a user, and intended to request summary information related to one or more projects. The input text 230 may be referred to as a prompt. The input text 230, which requests summary information for one or more projects, may be input to the first AI model 210. For example, input text 230 that reads “Generate summary information for Project A” may be provided to the first AI model 210. In another example, input text 230 that reads “Generate summary information for all projects conducted from January to June 2023” may be input to the first AI model 210.

The first AI model 210 may identify one or more projects included in the input text 230 and generate a plurality of pieces of summary information 240_1, 240_2, . . . , 240_n for the identified projects. In one embodiment, the first AI model 210 may identify a specific project included in the input text 230 and generate a plurality of pieces of category-specific summary information 240_1, 240_2, . . . , 240_n for the identified project. For example, the first AI model 210 may extract a plurality of category-specific data related to the specific project from the storage 130 and generate category-specific summary information based on the extracted category-specific data. As an example, the first AI model 210 may search for and summarize a plurality of data related to the specific project in a first database, thereby generating summary information for the specific project in a first category. Similarly, the second AI model 220 may search for and summarize a plurality of data related to the specific project in a second database, thereby generating summary information for the specific project in a second category.

In some embodiments, the input text 230 may include a specific time period for the specific project. In this case, the first AI model 210 may extract a plurality of category-specific data related to the specific project, stored during the specific time period, from the storage 130 and generate category-specific summary information based on the extracted category-specific data.

The first AI model 210 may include a language model capable of processing natural language. For example, the first AI model 210 may include a natural language processing model such as large language models (LMM), Bidirectional Encoder Representations from Transformers (BERT), or Generative Pretrained Transformers (GPT). The first AI model 210 may be trained through supervised or semi-supervised learning to identify one or more projects from input text expressed in natural language and summarize data retrieved from the storage 130 for the identified projects.

The plurality of pieces of category-specific summary information 240_1, 240_2, . . . , 240_n may be input to the second AI model 220, and the second AI model 220 may generate the plurality of pieces of card-type information 250_1, 250_2, . . . , 250_n based on the plurality of pieces of category-specific summary information 240_1, 240_2, . . . , 240_n. In one embodiment, the second AI model 220 may detect a pattern within the plurality of pieces of category-specific summary information 240_1, 240_2, . . . , 240_n and output the plurality of pieces of card-type information 250_1, 250_2, . . . , 250_n based on the detected pattern. For example, the second AI model 220 may calculate confidence scores for the plurality of pieces of summary information 240_1, 240_2, . . . , 240_n as the pattern. The confidence score may quantify the reliability of each of the plurality of pieces of summary information 240_1, 240 2, . . . , 240_n. In one embodiment, the confidence score for first summary information may be calculated based on the frequency of overlapping words or keywords between the first summary information and other summary information. Here, the keywords may be words considered important for understanding the specific project. For example, words related to the personnel in charge, project deadlines, meeting locations, meeting attendees, meeting schedules, and progress details may be determined as the keywords.

In one embodiment, the second AI model 220 may select one or more pieces of summary information 240_1, 240_2, . . . , 240_n based on their confidence scores and use the selected summary information to generate one or more pieces of card-type information 250_1, 250_2, . . . , 250_n. In some embodiments, the second AI model 220 may be configured to generate a number of pieces of card-type information 250_1, 250_2, . . . , 250_n corresponding to the number of selected pieces of summary information 240_1, 240_2, . . . , 240_n. Additionally, specific card-type information 250_1, 250_2, . . . , 250_n may be generated based on specific summary information 240_1, 240_2, . . . , 240_n. For example, specific card-type information 250_1, 250_2, . . . , 250_n may be generated by processing specific summary information 240_1, 240_2, . . . , 240_n. Here, processing may involve extracting necessary information from the specific summary information 240_1, 240_2, . . . , 240_n, adding additional data, or transforming the data included in the specific summary information 240_1, 240_2, . . . , 240_n to generate the card-type information 250_1, 250_2, . . . , 250_n. In one embodiment, the second AI model 220 may be trained through supervised or semi-supervised learning using multiple datasets for training.

FIG. 3 is a diagram illustrating an artificial neural network model 300 according to an embodiment of the present disclosure. Referring to FIG. 3, the artificial neural network model 300, which is an example of a machine learning model, may be a statistical learning algorithm implemented based on the architecture of a biological neural network, or a structure for executing the statistical learning algorithm, in the fields of machine learning and cognitive science. In some embodiments, the artificial neural network model 300 may be included in at least one of the first AI model 210 or the second AI model 220. That is, at least one of the first AI model 210 or the second AI model 220 may be implemented in the form of the artificial neural network model 300.

In one embodiment, the artificial neural network model 300, as in a biological neural network, may represent a machine learning model capable of problem-solving by repeatedly adjusting synaptic weights of artificial neurons, or nodes, which form a network through synaptic connections, to minimize the error between the correct output corresponding to a specific input and the inferred output. For example, the artificial neural network model 300 may include a probabilistic model or a neural network model used in machine learning or deep learning.

The artificial neural network model 300 may be implemented as a multilayer perceptron (MLP) consisting of multiple layers of nodes and their connections. The artificial neural network model 300 may be implemented using one of various artificial neural network structures that include an MLP. The artificial neural network model 300 may include an input layer for receiving input signals or data from an external source, an output layer for outputting signals or data corresponding to the input data, and n hidden layers (where n is a positive integer) located between the input and output layers, for receiving signals from the input layer, extracting features from the received signals, and transmitting the extracted features to the output layer.

In the artificial neural network model 300, a plurality of input variables and a plurality of output variables respectively corresponding to the plurality of input variables may be matched at the input and output layers, respectively. By adjusting the synaptic weights between nodes included in the input, hidden, and output layers, the artificial neural network model 300 can be trained to extract a correct output corresponding to a specific input. When the artificial neural network model 300 is iteratively trained based on data included in a training dataset, the synaptic weights (or weights) between the nodes are adjusted to reduce the error between output variables calculated from the input variables and target outputs, eventually converging to optimal values.

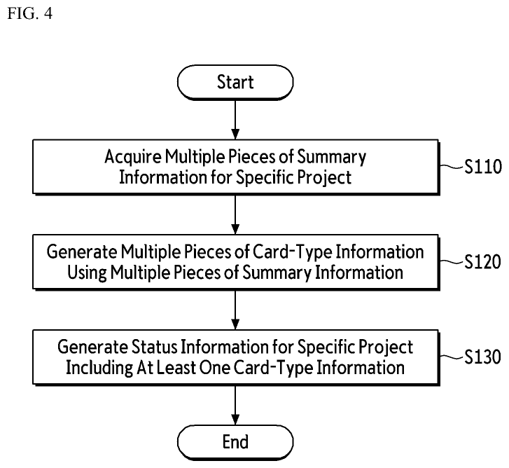

Various embodiments of a work support method according to the present disclosure will hereinafter be described with reference to FIGS. 4 through 11. Methods to be described below are merely examples for achieving the objectives of the present disclosure, and some steps may be added or omitted as necessary. Furthermore, the methods to be described below may be executed by at least one processor included in a computing system. For convenience of explanation, steps of the methods to be described below will be described as being performed by the work support server depicted in FIG. 1.

FIG. 4 is a flowchart for explaining a method of generating status information for a project according to an embodiment of the present disclosure.

Referring to FIG. 4, a work support server may acquire a plurality of pieces of summary information for a specific project using a plurality of data stored in a storage (S110). Here, the plurality of pieces of summary information may be associated with different categories. For example, the plurality of pieces of summary information may include first summary information associated with a first category and second summary information associated with a second category, the first category may be associated with a plurality of data generated through a first application, and the second category may be associated with a plurality of data generated through a second application. Here, the plurality of data generated through the first application may be stored in a first database, and the plurality of data generated through the second application may be stored in a second database. In some embodiments, the work support server may acquire a plurality of pieces of summary information from a first AI model by inputting text requesting information related to a specific project into the first AI model. For example, when a request to generate status information for the specific project is received from a user terminal, the work support server may automatically generate text giving instructions to generate summary information for the specific project and input the generated text into the first AI model. For example, the work support server may generate text such as “Generate summary information for Project A” and input it into the first AI model.

Thereafter, the work support server may generate a plurality of pieces of card-type information, which are displayed in card form and associated with different categories, based on the acquired summary information (S120). In one embodiment, the work support server may acquire the plurality of pieces of card-type information from a second AI model by inputting the plurality of pieces of summary information into the second AI model. As described above, the second AI model may be configured to output data related to the plurality of pieces of card-type information based on the plurality of pieces of summary information. In one embodiment, the second AI model may be configured to calculate confidence scores for the plurality of pieces of summary information, select at least one of the plurality of pieces of summary information based on the calculated confidence scores, and generate the plurality of pieces of card-type information using the selected piece of summary information. In some embodiments, the second AI model may calculate the confidence scores for the plurality of pieces of summary information based on the frequency of overlapping keywords or words within each of the plurality of pieces of card-type information.

Thereafter, the work support server may generate status information for the specific project, including at least one of the plurality of pieces of card-type information (S130). Here, the confidence score of the piece of card-type information included in the status information may be greater than or equal to a threshold.

The generated status information may be transmitted to a user terminal. In one embodiment, when a request for status information related to a specific project is received from the user terminal, the work support server may transmit the generated status information to the user terminal. A portion of first card-type information included in the status information may be displayed in a first output area of the user terminal, and a portion of second card-type information may be displayed in a second output area of the user terminal. An example of how to display card-type information on a user terminal will be described later with reference to FIG. 7.

In some embodiments, the work support server may acquire a plurality of pieces of summary information for multiple projects and generate a plurality of pieces of card-type information for each of the multiple projects based on the acquired summary information. The work support server may then generate status information for each of the multiple projects based on the plurality of pieces of card-type information. That is, the work support server may generate status information for multiple projects, rather than for a single project.

According to the present embodiment, status information for a specific project may be automatically generated based on text and may then be provided to a user. The user may conveniently and intuitively recognize information regarding the specific project based on the status information.

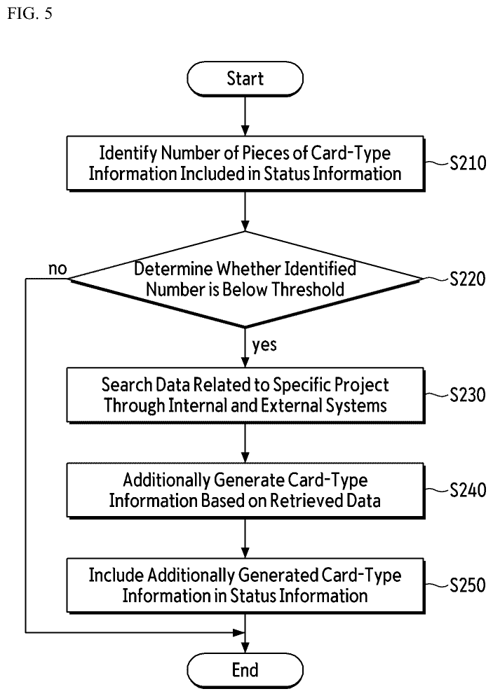

FIG. 5 is a flowchart for explaining a method of generating additional card-type information and including the generated additional information in status information, according to an embodiment of the present disclosure. The method illustrated in FIG. 5 may be performed after the method illustrated in FIG. 4.

Referring to FIG. 5, when status information for a specific project is generated, the work support server may identify the number of pieces of card-type information included in the generated status information (S210).

The work support server may then determine whether the identified number of pieces of card-type information is greater than or equal to a threshold (S220). If the number of pieces of card-type information included in the status information is determined to be below the threshold, the work support server may search for and find data regarding the specific project in at least one of an internal system and an external system (S230). Here, the internal system may include one or more servers within an internal network, and the external system may include external web servers such as portal sites. Here, a search keyword may be determined based on a summary for the specific project. For example, at least one of the name or subject of the specific project may be used as the search keyword.

Thereafter, the work support server may additionally generate card-type information based on the found data (S240). At this time, the work support server may acquire summary information for the found data by inputting the found data into the first AI model, and may generate additional card-type information based on the acquired summary information. In some embodiments, the work support server may acquire additional card-type information from the second AI model by inputting the acquired summary information into the second AI model.

The work support server may then include the additionally generated card-type information in the status information (S250). As the additional card-type information is included in the status information, the comprehensiveness of the status information can be enhanced.

Meanwhile, a plurality of pieces of card-type information may be additionally generated through a search, and may then be included in the status information.

According to the present embodiment, if the initially generated status information does not contain sufficient card-type information, additional card-type information may be generated based on data retrieved from an external or internal system and included in the status information. As a result, sufficient data may be contained in the status information.

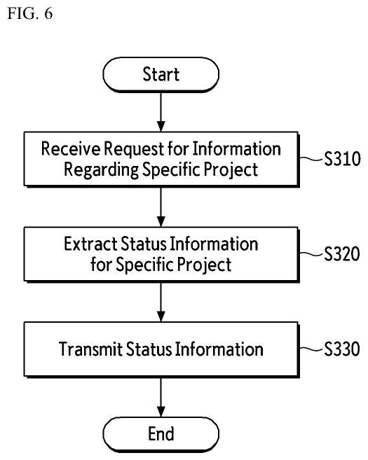

FIG. 6 is a flowchart for explaining a method of providing status information for a project according to an embodiment of the present disclosure.

Referring to FIG. 6, the work support server may receive a request for information regarding a specific project from a user terminal (S310).

Thereafter, the work support server may extract status information for the specific project (S320). Here, the status information may include a plurality of pieces of card-type information.

The work support server may then transmit the extracted status information to the user terminal (S330). In one embodiment, a portion of first card-type information included in the status information may be displayed in a first output area of the user terminal, and a portion of second card-type information may be displayed in a second output area of the user terminal.

In some embodiments, status information for a specific project may be generated on a periodic basis. In some embodiments, for a long-term project, the work support server may generate status information at predetermined time intervals. Periodic status information may be generated using a plurality of AI models, as mentioned earlier.

When periodic status information is stored, the work support server may receive a request for the information regarding the specific project from the user terminal. In this case, the work support server may extract periodic status information for the specific project and transmit the extracted periodic status information to the user terminal. Then, the user terminal may display the periodic status information for the specific project in a timeline format.

FIG. 7 is a diagram illustrating a state where a plurality of pieces of card-type information included in status information are displayed, according to an embodiment of the present disclosure.

Referring to FIG. 7, a plurality of pieces of card-type information 710_1 through 710_7 may be displayed in relation to an ABC project. The plurality of pieces of card-type information 710_1 through 710_7 may be associated with different categories. For example, first card-type information 710_1 may be associated with a meeting category, second card-type information 710_2 may be associated with a collaboration solution category, third card-type information 710_3 may be associated with an email category, and fourth card-type information 710_4 may be associated with a first messenger category.

Additionally, fifth card-type information 710_5, which is a piece of card-type information added through an internal network search, may be associated with an internal network search category. Sixth card-type information 710_6, which is a piece of card-type information added through an external system, may be associated with an external system search category. Furthermore, seventh card-type information 710_7 may be associated with a second messenger category.

The status information displayed on the user terminal may include various menus. As illustrated in FIG. 7, “MY GEN AI HOME,” which is a menu that allows the user to navigate to the home screen, may be used to check status information for various projects in addition to the ABC project. Additionally, when a menu 730 for adding project status information is selected, a tab for checking status information related to projects other than the ABC project may be added to the status information.

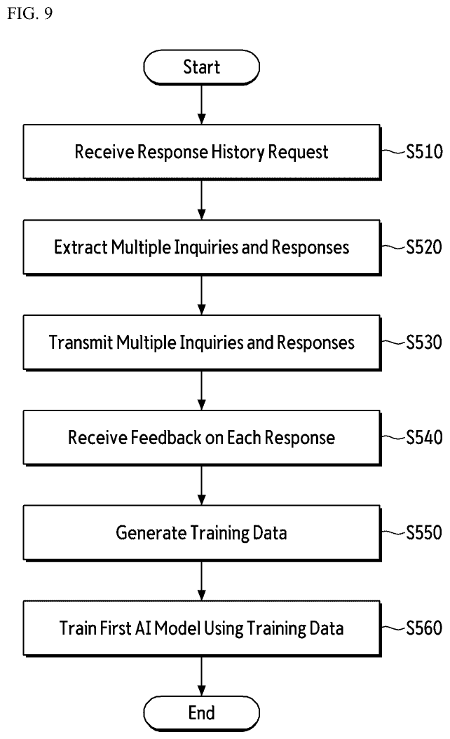

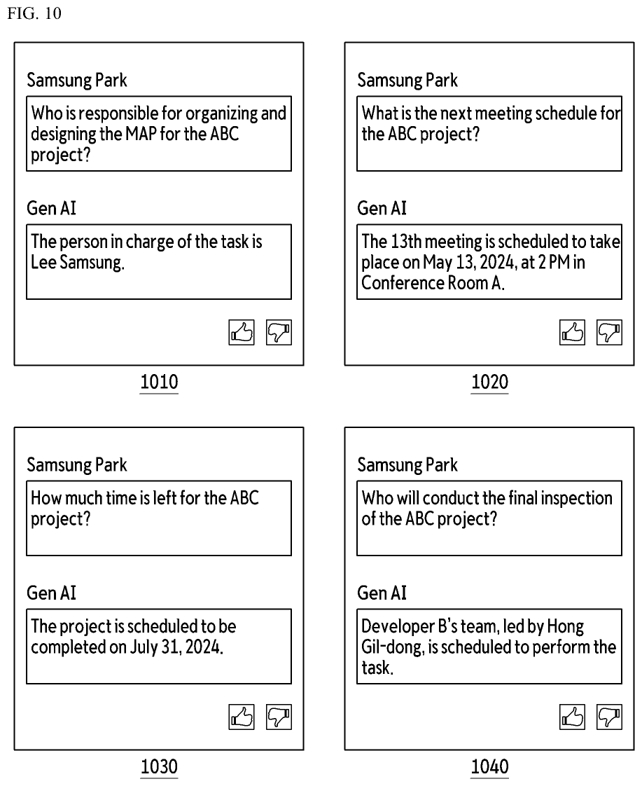

When a “View Answer History” menu 750 is selected, automatic responses to inquiries related to the ABC project may be retrieved and transmitted to the user terminal. A detailed explanation of the history of the responses will be provided later with reference to FIGS. 9 and 10.

According to the present embodiment, status information for a specific project functions as a type of dashboard, allowing the user to easily grasp the status of the specific project based on the status information.

An automatic response setting that requests the automatic generation of responses to inquiries based on the status information may be input via an input field 740. In FIG. 7, an exemplary automatic response setting is illustrated as “If an inquiry is received regarding the ABC project, respond on my behalf.” The automatic response setting may be expressed in natural language, and only the name of a specific project may also be entered.

Once the automatic response setting is input, responses to inquiries may be automatically generated and provided based on the status information.

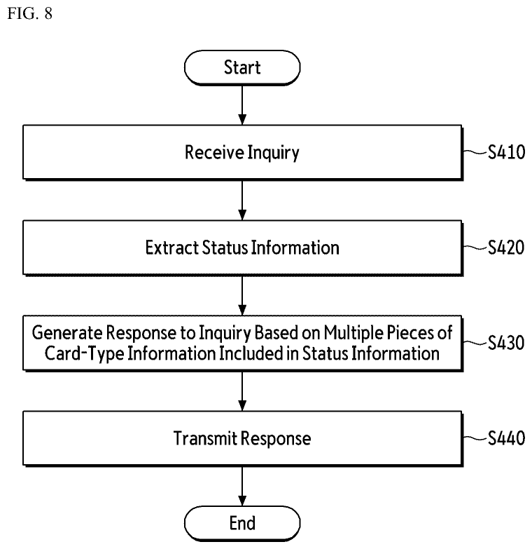

FIG. 8 is a flowchart for explaining a method of automatically generating and transmitting a response according to an embodiment of the present disclosure. When an automatic response setting is input for a specific project, a function (hereinafter referred to as the “chatbot function”) for automatic responses for the specific project may be activated. When the chatbot function is activated, the method depicted in FIG. 8 may be executed.

Referring to FIG. 8, when the chatbot function for the specific project is activated, the work support server may receive an inquiry related to the specific project from a user terminal (S410). For example, the inquiry may include at least one of a word, phrase, or sentence containing the name of the specific project.

Thereafter, the work support server may identify the name of the specific project included in the inquiry and extract status information related to the specific project (S420). Then, based on a plurality of pieces of card-type information included in the status information, the work support server may automatically generate a response to the inquiry (S430). In one embodiment, the work support server may acquire a response from the first AI model by inputting text instructing the first AI model to generate a response based on the plurality of pieces of card-type information included in the status information. For example, if the inquiry is “Who is responsible for organizing and designing the MAP of the ABC project?,” the work support server may input text that reads “Refer to the status information of the ABC project and generate a response to the inquiry, “Who is responsible for organizing and designing the MAP of the ABC project?,” into the first AI model.

The first AI model may be configured to generate a response to the inquiry by referring to the plurality of pieces of card-type information in the status information in descending order of confidence scores. For example, if the first AI model fails to generate a response using first card-type information with a highest confidence score, the first AI model may attempt to generate a response by referring to second card-type information with a second highest confidence score.

In some embodiments, the work support server may receive user input selecting one or more pieces of card-type information from among the plurality of pieces of card-type information included in the status information to be used for generating a response to the inquiry. In this case, the work support server may generate a response to the inquiry based on the one or more pieces of card-type information selected by the user. The work support server may input text giving instructions to generate a response to the inquiry to the first AI model and may acquire a response to the inquiry from the first AI model. For example, if the inquiry is “Who is responsible for organizing and designing the MAP of the ABC project?” and the user selects the first card-type information and the second card-type information from the status information, the work support server may input text that reads “Refer to the first card-type information and the second card-type information included in the ABC project's status information and generate a response to the inquiry, “Who is responsible for organizing and designing the MAP of the ABC project?,” into the first AI model.

Thereafter, the work support server may transmit the generated response to the user terminal (S440).

According to the present embodiment, when an inquiry regarding the specific project is received, a response to the inquiry may be automatically generated and transmitted to the user terminal based on one or more pieces of card-type information included in the status information for the specific project. As a result, responses to inquiries may be provided quickly, and the burden on administrators in generating responses may be reduced. Furthermore, since responses are generated based on project status information, the accuracy of the responses may be improved.

FIG. 9 is a flowchart for explaining a method of fine-tuning the first AI model through retraining based on user feedback on responses, according to an embodiment of the present disclosure.

Referring to FIG. 9, the work support server may receive a response history request for a specific project from a user terminal (S510). For example, when the “View Response History” menu 750 illustrated in FIG. 7 is selected, the work support server may receive a response history request for the specific project. Here, the user terminal may be a terminal possessed by the user who manages work status.

Thereafter, the work support server may extract a plurality of inquiries related to the specific project and a plurality of responses respectively corresponding to the plurality of inquiries (S520). When an inquiry regarding the specific project is received and a response is automatically generated, the inquiry and response may be stored together in a repository or storage of the work support server, and the work support server may extract multiple stored inquiries and responses. In one embodiment, the multiple inquiries and responses may be stored in a folder for the specific project.

Thereafter, the work support server may transmit the extracted inquiries and responses to the user terminal (S530).

After reviewing the extracted inquiries and responses, the user may input positive or negative feedback on each response. In this case, the work support server may receive positive or negative feedback on each response from the user terminal (S540).

FIG. 10 is a diagram illustrating a plurality of inquiries and responses transmitted to and displayed on a user terminal. Referring to FIG. 10, response history including a plurality of pairs 1010, 1020, 1030, and 1040 of inquiries and responses may be transmitted to and displayed on the user terminal. Icons for submitting positive or negative feedback on each response may be displayed on the user terminal's screen. In FIG. 10, a thumbs-up icon is illustrated as a positive feedback icon, and a thumbs-down icon is illustrated as a negative feedback icon.

Additionally, in FIG. 10, each inquiry directly input by other users is displayed at the top, and each response generated by the first AI model (e.g., Gen AI) is displayed at the bottom. The user may verify whether each response is appropriate. Then, for a response determined to be appropriate, the user may select the positive feedback icon. Conversely, for a response determined to be inadequate, the user may select the negative feedback icon.

Referring back to FIG. 9, the work support server may generate multiple training datasets including positive or negative feedback, inquiries, and responses (S550). For example, a first training dataset may include a first inquiry, a first response to the first inquiry, and feedback on the first response (e.g., positive or negative feedback), and an n-th training dataset (where n is an integer greater than or equal to 2) may include an n-th inquiry, an n-th response to the n-th inquiry, and feedback on the n-th response (e.g., positive or negative feedback).

Thereafter, the work support server may additionally train the first AI model using the multiple training datasets (S560). Here, the additional training of the first AI model may be understood as fine-tuning the first AI model. When positive feedback is included in a training dataset, the first AI model may be trained to generate a similar response to that included in the training dataset when receiving a similar inquiry to that included in the training dataset. Conversely, when negative feedback is included in a training dataset, the first AI model may be trained to generate a different response from that included in the training dataset when receiving a similar inquiry to that included in the training dataset.

According to the present embodiment, the user may review response history and provide feedback to improve response accuracy. Based on the user's feedback, the first AI model may be fine-tuned, enabling the automatic generation of more accurate responses.

Meanwhile, when the scheduled time for updating status information for a specific project arrives, the status information may be updated.

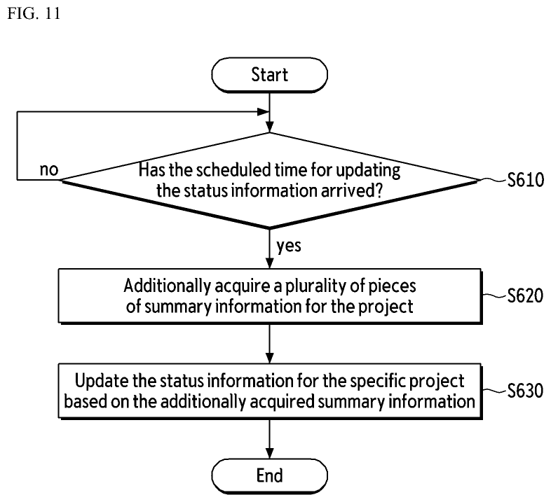

FIG. 11 is a flowchart for explaining a method of updating status information for a specific project, according to an embodiment of the present disclosure.

Referring to FIG. 11, the work support server may determine whether the scheduled time for updating status information for a specific project has arrived (S610). Here, the scheduled time for updating the status information may be a predetermined date/time, the time when an inquiry is received, or the time when responses to inquiries are found to be insufficient. In some embodiments, the scheduled time for updating the status information for the specific project may be determined when additional data related to the specific project is detected as being stored in the storage with a size exceeding a threshold. For example, if the status information for the specific project is generated at a first time and at a second time, the additional data related to the specific project is detected as being stored in the storage with a size exceeding the threshold, the work support server may determine that the second time is the scheduled time for updating the status information for the specific project.

Thereafter, upon the arrival of the scheduled time for updating the status information for the specific project, the work support server may additionally acquire a plurality of pieces of summary information for the specific project based on a plurality of data stored in the storage (S620). In one embodiment, the work support server may extract a plurality of additional data related to the specific project that have been stored in the storage since the generation of the status information for the specific project, and may additionally acquire a plurality of pieces of summary information based on the extracted data by inputting the extracted data into the first AI model. Here, the plurality of pieces of summary information may be associated with different categories.

Thereafter, the work support server may update the status information for the specific project based on the additionally acquired a plurality of pieces of summary information (S630). In one embodiment, the work support server may additionally acquire a plurality of pieces of card-type information from the second AI model by inputting the additionally acquired summary information into the second AI model. Furthermore, the work support server may update the status information for the specific project so that the additionally acquired card-type information may be reflected in the status information.

According to the present disclosure, when a long-term project is in progress, the status information for a specific project may be continuously updated, enabling an efficient management of status information for the long-term project.

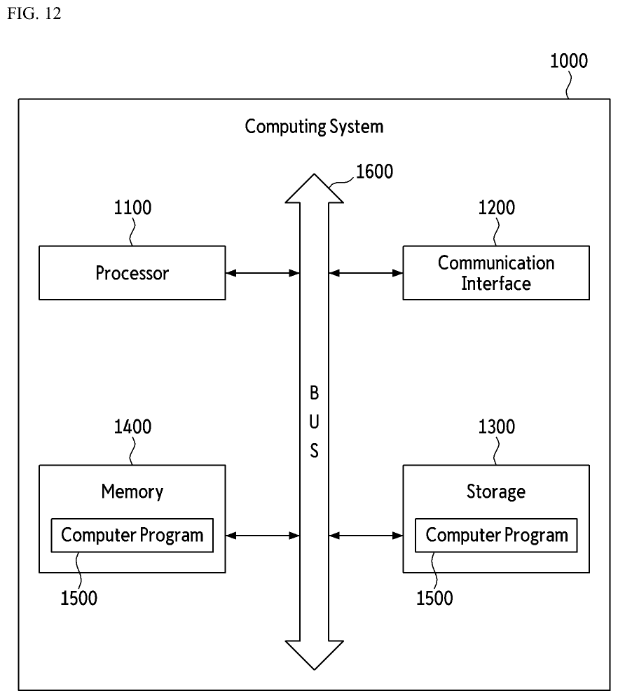

FIG. 12 is a hardware configuration view of an exemplary computing system 1000 according to some embodiments of the present disclosure. The computing system 1000 may include at least one processor 1100, a bus 1600, a communication interface 1200, a memory 1400, which loads a computer program 1500 to be executed by the processor 1100, and a storage 1300, which stores the computer program 1500.

The computing system 1000 of FIG. 12 may present a hardware structure of a computing system that constitutes the work support server 120 described with reference to FIG. 1.

The processor 1100 may control the overall operations of the components of the computing system 100. The processor 1100 may perform operations related to at least one application or program to execute operations/methods according to various embodiments of the present disclosure. The memory 1400 may store various data, commands, and/or information. The memory 1400 may load the computer program 1500 from the storage 1300 to execute the operations/methods according to various embodiments of the present disclosure. The storage 1300 may non-transitorily store at least one computer program 1500.

The computer program 1500 may include one or more instructions that enable the processor 1100 to perform the operations/methods according to various embodiments of the present disclosure when loaded into the memory 1400. In other words, by executing the loaded instructions, the processor 1100 may perform the operations/methods according to various embodiments of the present disclosure.

According to one embodiment, the computer program 1500 may comprise instructions for operations of acquiring a plurality of pieces of summary information for a specific project using a plurality of data stored in a storage, the plurality of pieces of summary information being associated with different categories; generating a plurality of pieces of card-type information associated with different categories using the plurality of pieces of summary information; and generating status information for the specific project including at least one of the plurality of pieces of card-type information.

In some embodiments, the computing system 1000 as described with reference to FIG. 12 may be configured using one or more physical servers included in a server farm based on cloud technology such as virtual machines. In this case, at least some of the components as illustrated in FIG. 12, such as the processor 1100, the memory 1400, and the storage 1300 may be virtual hardware, and the communication interface 1200 may also be embodied as a virtualized networking element such as a virtual switch.

So far, a variety of embodiments of the present disclosure and the effects according to embodiments thereof have been mentioned with reference to FIGS. 1 to 12. The effects according to the technical idea of the present disclosure are not limited to the forementioned effects, and other unmentioned effects may be clearly understood by those skilled in the art from the description of the specification.

The methods according to the embodiments of the present disclosure described above may be performed by executing a computer program implemented using a computer-readable code. The computer program may be transmitted from a first computing device to a second computing device via a network such as the Internet and installed on the second computing device, and may be used by the second computing device. Furthermore, although the operations are illustrated in a specific order in the drawings, it should not be understood that the operations should be executed in the specific order as illustrated or in a sequential order or that all illustrated operations should be executed to acquire a desired result. In certain situations, multitasking and parallel processing may be advantageous.

Although some embodiments of the present disclosure have been described above with reference to the accompanying drawings, the present disclosure may not be limited to some embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A work support method performed by a computing system, the work support method comprising:
acquiring a plurality of pieces of summary information for a specific project using a plurality of data stored in a storage, the plurality of pieces of summary information being associated with different categories;
generating a plurality of pieces of card-type information associated with different categories, using the plurality of pieces of summary information; and
generating status information for the specific project including at least one of the plurality of pieces of card-type information.

2. The work support method of claim 1, wherein
the plurality of pieces of summary information include first summary information associated with a first category and second summary information associated with a second category,
the first category is associated with a plurality of data generated through a first application, and
the second category is associated with a plurality of data generated through a second application.

3. The work support method of claim 1, wherein the acquiring the plurality of pieces of summary information for the specific project comprises: inputting text requesting information related to the specific project into a first artificial intelligence (AI) model; and acquiring the plurality of pieces of summary information through the first AI model.

4. The work support method of claim 1, wherein
the generating the plurality of pieces of card-type information comprises: inputting the plurality of pieces of summary information into a second AI model; and acquiring the plurality of pieces of card-type information through the second AI model, and
the second AI model is configured to output the plurality of pieces of card-type information based on the plurality of pieces of summary information.

5. The work support method of claim 4, wherein the second AI model is configured to: calculate confidence scores for the plurality of pieces of summary information, select at least one of the plurality of pieces of summary information based on the calculated confidence scores, and output the plurality of pieces of card-type information using the selected at least one piece of summary information.

6. The work support method of claim 5, wherein the second AI model is further configured to calculate the confidence scores for the plurality of pieces of summary information based on a frequency of overlapping keywords or words included in each of the plurality of pieces of card-type information.

7. The work support method of claim 1, further comprising:
after the generating the status information, receiving an inquiry related to the specific project from a user terminal;
generating a response to the inquiry based on the plurality of pieces of card-type information included in the status information; and
transmitting the generated response to the user terminal.

8. The work support method of claim 7, wherein the generating the response to the inquiry comprises: inputting text instructing a first AI model to generate a response to the inquiry by referring to the plurality of pieces of card-type information included in the status information into the first AI model; and acquiring the response from the first AI model.

9. The work support method of claim 8, wherein the first AI model is configured to generate the response to the inquiry by referring to the plurality of pieces of card-type information in descending order of confidence scores.

10. The work support method of claim 7, wherein the generating the response to the inquiry comprises: receiving user input selecting at least one piece of card-type information for generating a response from among the plurality of pieces of card-type information included in the status information; and generating the response based on the at least one piece of card-type information selected by a user.

11. The work support method of claim 1, further comprising:
after the generating the status information, receiving a request for information regarding the specific project from a user terminal; and
transmitting the status information to the user terminal,
wherein
a portion of first card-type information included in the status information is displayed in a first output area of the user terminal, and
a portion of second card-type information included in the status information is displayed in a second output area of the user terminal.

12. The work support method of claim 1, further comprising:
after the generating the status information, receiving a request for information regarding the specific project from a user terminal;
extracting periodic status information for the specific project; and
transmitting the periodic status information to the user terminal.

13. The work support method of claim 1, further comprising:
after the generating the status information, receiving a response history request from a user terminal;
extracting inquiries and responses to the inquiries; and
transmitting the extracted inquiries and responses to the user terminal.

14. The work support method of claim 13, further comprising:
receiving positive or negative feedback on the responses from the user terminal; and
generating training data including the positive or negative feedback, the inquiries, and the responses,
wherein the training data is used to additionally train a first AI model.

15. The work support method of claim 1, further comprising:
after the generating the status information, determining whether a number of pieces of card-type information included in the status information is greater than or equal to a threshold;
when the number of pieces of card-type information included in the status information is less than the threshold, searching for and finding data related to the specific project in at least one of an internal system and an external system;
additionally generating card-type information based on the found data; and
including the additionally generated card-type information in the status information.

16. The work support method of claim 1, further comprising:
after the generating the status information, when a scheduled time for updating the status information arrives, additionally acquiring a plurality of pieces of summary information for the specific project based on the plurality of data stored in the storage; and
updating the status information for the specific project based on the additionally acquired summary information.

17. The work support method of claim 16, wherein when an inquiry regarding the specific project is received, it is determined that the scheduled time for updating the status information has arrived.

18. The work support method of claim 16, wherein when additional data related to the specific project is detected as being stored in the storage with a size exceeding a threshold, it is determined that the scheduled time for updating the status information has arrived.

19. A computing system comprising:
one or more processors; and
a memory storing a computer program executed by the one or more processors,
wherein the computer program includes instructions for operations of: acquiring a plurality of pieces of summary information for a specific project using a plurality of data stored in a storage, the plurality of pieces of summary information being associated with different categories; generating a plurality of pieces of card-type information associated with different categories using the plurality of pieces of summary information; and generating status information for the specific project including at least one of the plurality of pieces of card-type information.

20. A non-transitory computer-readable recording medium comprising instructions,
wherein when executed by a processor, the instructions enable the processor to perform operations of: acquiring a plurality of pieces of summary information for a specific project using a plurality of data stored in a storage, the plurality of pieces of summary information being associated with different categories; generating a plurality of pieces of card-type information associated with different categories using the plurality of pieces of summary information; and generating status information for the specific project including at least one of the plurality of pieces of card-type information.
